(19) United States
(12) Patent Application Publication
(10) Pub. No.: US 2020/0361751 A1
(43) Pub. Date: Nov. 19, 2020

(54) METHOD FOR RAISING AND/OR LOWERING A LOAD-HANDLING ELEMENT OF A LIFTING DEVICE, IN PARTICULAR OF A CRANE, AN DLIFTING DEVICE THEREFOR

(71) Applicant: Konecranes Global Corporation, Hyvinkää (FI)

(72) Inventor: Giuliano Persico, Wetter (DE)

(21) Appl. No.: 16/636,016

(22) PCT Filed: Aug. 3, 2018
(86) PCT No.: PCT/EP2018/071159

§ 371 Date: Feb. 2, 2020

(30) Foreign Application Priority Data
Aug. 3, 2017 (DE) 10 2017 117 662.4

(51) Int. Cl. B66C 13/06; B66C 17/00; B66C 13/16

(52) U.S. Cl. CPC B66C 13/063; B66C 13/16; B66C 17/00

(57) ABSTRACT

A crane lifting device, and method for raising and/or lowering a load-handling element of a crane lifting device, allows for operating the lifting device with a first velocity or with a second velocity greater than the first velocity, by means of a control unit. To achieve a reduction in impulses while raising the load-handling element, and to achieve an extended service life of the supporting means, an inclination sensor is used to determine an inclination angle of the load-handling element and/or a state sensor is used to determine a free or occupied state of the load-handling element. An evaluating unit interacts with the control unit in such a way that, depending on the determined inclination angle and/or the determined free or occupied state, the evaluation unit prevents or permits operation of the lifting device with the second velocity by means of the control unit.

### CROSS REFERENCE TO RELATED APPLICATIONS

The present application is a § 371 national stage of International Application PCT/EP2018/071159, filed Aug. 3, 2018, which claims priority benefit of German Pat. Application DE 10 2017 117 662.4, filed Aug. 3, 2017.

### FIELD OF THE INVENTION

The invention relates to a method for lifting and/or lowering a load handling means of a hoist, in particular of a crane.

### BACKGROUND

In order to reduce impulses which occur when lifting the load handling means, it is the responsibility of the respective operator to operate the hoist for lifting the load handling means with a load attached to the load handling means not at the higher speed but at the lower speed until the load is raised, and to operate the hoist at the higher speed only after the load is raised and thereby to continue to lift the load handling means and the load attached thereto. The impulses produced in conjunction with raising the load can thus be reduced in this manner only manually by the corresponding behaviour of the operator.

German laid-open document DE 10 2013 017 803 A1 discloses an erroneous location recognition system for a crane, in which a magnetic resistance is used to indirectly recognise whether the load parts to be picked up by the hook of the crane are located in the jaw region of the hook. The erroneous location recognition system also includes an inclination sensor arranged on the hook in order to prevent incorrect hooking when the inclination value determined by the inclination sensor exceeds a threshold value.

German laid-open document DE 10 2012 015 095 A1 describes a crane with an angle measuring unit that is fastened to the hook of the crane. This angle measuring unit can determine, by means of an inclination sensor, the deflection of the hook from the desired position, optionally from the vertical direction, and thereby prevent incorrect hooking of the load into the hook and permit secure gripping.

In relation to a lifting mechanism of a crane, which can travel by means of travel drives for lifting or lowering a load, it is known from German laid-open document DE 10 2015 002 864 A1 that the load is connected to an inclination sensor in order to actuate the travel drives of the crane in dependence upon the position of the load detected thereby as an angular position, such that swinging of the load is damped. This permits a more rapid and more stable compensation for perturbations, such as wind or other external disruptions on the load when travelling, and allows the load to be moved as quickly as possible.

The above-mentioned uses of inclination sensors in cranes are directed to correct or secure gripping of the load and movement of the load as quickly as possible and, where possible, without swinging.

Moreover, patent DE 29 30 439 C2 discloses a method for securely handling a hoist having at least two different lifting speeds. In this context, a switch is disclosed to switch between a higher lifting speed and a lower lifting speed depending upon a lifting cable force in order to avoid overloading of the hoist due to the vibrations that occur.

DE 10 2009 032 269 A1 relates to a crane controller for actuating a lifting mechanism of a crane, which takes into consideration vibration dynamics based on an extensibility of the lifting cable. For this purpose, the crane controller is equipped with a situation recognition means which recognises a picked-up state in which the drive speed of the lifting mechanism is limited for avoiding over-swinging. The crane controller recognises the picked-up state in that the change in the measured lifting force is monitored.

In order to recognise the state of a load-picking means as “occupied”, a load sensor, via which an increase in the load is recognised, is used in each of JP 2008 239258 A, JP H08 231193 A and JP 3 275422 B2.

US 2012/168397 A1 relates to the use of cable angle sensors for reducing or preventing swinging of already raised loads.

US 2010/201970 A1 and CN 102 249 162 A each relate to sonar winches which are used on ships or helicopters for lowering or raising sonar devices into or from the water. In this context, sensors for cable lift angles are described.

### SUMMARY OF THE INVENTION

The present invention provides a hoist and a corresponding method for lifting and/or lowering a load handling means of a hoist, in particular of a crane, that allow an automatic reduction of impulses when lifting the load handling means and provide for a longer service life of the carrying means. In accordance with an aspect of the invention, a method for lifting and/or lowering a load handling means of a hoist, in particular of a crane, having a flexible carrying means to which the load handling means to be lifted is attached, wherein the hoist can be operated at least at a first speed or at a second speed by means of a control unit for lifting and/or lowering the load handling means, wherein the first speed is lower than the second speed, by virtue of the fact that an inclination angle of the load handling means is determined by means of an inclination sensor and/or whether the load handling means is free or occupied is determined as a state of the load handling means by means of a state sensor, for which purpose the state sensor is formed such that it is able to detect an object, or the presence or absence thereof, and that as a result the state “free” and also the state “occupied” can be recognised for the load handling means irrespective of its position or inclination and also irrespective of any load forces, in particular lifting cable forces, and that an evaluation unit cooperates with the control unit such that the hoist is prevented or permitted by the evaluation unit, in dependence upon the determined inclination angle and/or the determined state of the load handling means, to operate at the second speed by means of the control unit. This advantageously permits automatic reduction of impulses when lifting the load handling means and in particular permits an extended service life of the carrying means.

In accordance with another aspect of the invention, when lifting and/or lowering the load handling means, sensor-based situation recognition or monitoring and, based thereon, situation-dependent, in particular automatic, permitting or preventing the second speed by the evaluation unit occurs, which automatically ensures a reduction of impulses when lifting the load handling means and in particular ensures a longer service life of the carrying means.

The inclination sensor and/or the state sensor may be arranged on the load handling means. In order to, in particular automatically, permit or prevent the second speed in this sense, provision can be made that the control unit has to receive an enable signal generated by the evaluation unit for permitting the second speed or has to receive a blocking signal for preventing the second speed. If the enable signal or blocking signal is absent, i.e. is not received by the control unit because it is not even generated by the evaluation unit or transmission to the control unit is prevented, the second speed is prevented or permitted respectively as a result. Alternatively, in order to automatically permit or prevent the second speed by the evaluation unit, the generation or at least transmission of a corresponding blocking signal or enable signal is prevented and the second speed is permitted or prevented, respectively, as a result. Situation-dependent prevention then occurs such that control commands triggered by an operator, which are directed to causing the second speed in terms of speed desired values, are processed by the control unit such that the hoist is operated only at a lower speed compared with the prevented second speed, such as the first speed. Corresponding control commands can also be ignored by the control unit and so no lifting or lowering movements are performed at all. In order for the hoist to be able to be operated at the second speed, the control unit must be permitted to do this by the evaluation unit accordingly depending upon the situation. Typical values for the first speed (v1) are in a range of approximately 1 to 2 m/min. If a multiple-speed three-phase asynchronous machine is used as the electric motor of the lifting drive, v1/v2 ratios of 1/6, 1/4, 2/4 or even 2/6 are feasible.

If more than two speeds are possible, such as within a continuous speed range of a corresponding electric motor, a plurality of speeds can also be prevented or enabled. A prevented second speed can hereby also represent an upper limit for speeds permitted within the speed range, including the first speed. For a continuous lifting drive or associated electric motor, the v1/v2 ratio can increase considerably, and may be for example 1:100.

In particular, by means of the method in accordance with yet another aspect of the invention, situations can be recognised when lifting the load handling means with a carrying means, which is generally flexible, of the hoist to which the load handling means to be lifted is attached, must initially be tightened in order to be able to absorb load forces, which emanate from the load-picking up means and any load attached thereto, and so then further lifting of the load handling means can occur by way of increasing lifting forces of the hoist, which lifting forces ultimately exceed the load forces, and as result the load can be raised. Such situations can be recognised without a state sensor solely in dependence upon the determined inclination angle. In these situations, there was hitherto still a risk of a critical impulse in conjunction with raising the load, in particular when the hoist is operated too quickly, in particular at the second speed, by an operator for accelerated tightening of the carrying means and is not decelerated or stopped in good time before the carrying means is sufficiently tightened in order to be able to start absorbing the above-mentioned load forces. By using the evaluation unit in accordance with the invention, too rapid operation of the hoist, in particular at the second speed, can automatically be prevented during tightening and thus before the load forces are introduced into the carrying means. As a result, unlike previously, operators are no longer able to operate the hoist at the second speed for accelerated tightening of the carrying means and thus before raising the load, and so jerky loading of the carrying means by the load forces and thus jerky raising of the load at the second speed can be prevented and only reduced impulses can act on the load-carrying parts of the hoist or crane.

On the whole, in an advantageous manner improved classifications of the lifting class and more favourable design of all the load-carrying parts of the hoist or crane can thereby be achieved. This is possible because lower calculation factors can be selected by reducing impulses for the calculation of the design of the load-carrying parts according to current standards for cranes and hoists.

Moreover, by means of the method in accordance with still another aspect of the invention, situations can be recognised when lowering the load handling means that there is a risk that the load handling means is completely set down on the ground and also the carrying means comes into contact with the ground and may pick up dirt which leads to premature wear or damage to the carrying means. This is applicable in particular when lubricated cables are used as the carrying means which are particularly liable to become dirty in this manner Such situations can be recognised without a state sensor and without a load sensor solely in dependence upon the determined inclination angle, and so then if need be a lowering operation of the hoist at the second speed is prevented and lowering can only be continued at a slower speed. In dependence upon the determined inclination angle, a lowering process can also be stopped and only a lifting operation may be possible. In this manner, corresponding fouling can be avoided and the service life of the carrying means can be extended.

Any sensor capable of measuring an angle can be used as an inclination sensor, in particular an inclinometer or accelerometer. Sensors which are able to detect an object or the presence/absence thereof can be used as possible state sensors. For example, optical sensors, in particular based on infrared waves, sensors which operate with radio waves, or even capacitive sensors are feasible. In the case of locating with radio waves, the lifting accessory can be provided with an RFID transponder and can be recognised and read-out by means of the state sensor. The state sensor can hereby also be formed as a proximity sensor reacting in a contactless manner. The state sensors that can be used in the present case are thus formed such that the “free” state and also the “occupied” state can be recognised for the load handling means independently of its position or inclination and also independently of any load forces, in particular lifting cable forces.

In an advantageous manner, the inclination angle is determined in relation to a rest position of the load handling means suspended on a carrying means of the hoist. The rest position corresponds to a swinging-free equilibrium position of the freely suspended load handling means in which the inclination angle is zero and the carrying means is tightened. As a result, a carrying means which is still to be tightened can be recognised as a situation because in this case there is an inclination angle which deviates from the rest position and thus from zero, the angle being able to be determined by the inclination sensor and being able to be recognised by the evaluation unit.

In an advantageous manner, provision can particularly be made that operation of the hoist at the second speed is prevented for lifting and/or lowering when the inclination angle reaches or exceeds a predetermined limit value, which is in particular less than 10°, preferably less than 5°, and in a particularly preferred manner is up to 4°, and optionally the state sensor recognises that the load handling means is occupied. The state sensor is optional for this embodiment and also for the other embodiments in which operation of the hoist at the second speed is meant to be prevented or permitted at least in dependence upon the determined inclination angle. The desired limit value for the inclination angle may optionally be set in the evaluation unit and predetermined thereby.

The circumstance is hereby used that a carrying means which is not yet sufficiently tightened can be recognised by a correspondingly large inclination angle. Since a load possibly attached to the load handling means also cannot yet be raised, there is thus a risk of a critical impulse in conjunction with raising the load, in particular immediately at the start of loading the carrying means by the above-mentioned load forces. This is prevented in that the evaluation unit prevents too rapid operation of the hoist, in particular at the second speed, in the case of a correspondingly large inclination angle and only permits operation slower than the second speed, in particular at the first speed. If additionally a state sensor is used, provision can be made that the second speed is only prevented when the state of the load handling means is detected as “occupied” because otherwise, i.e. when the state is “free”, there is no risk of critical impulse and as a result the second speed can also be permitted.

The recognition of a non-tightened carrying means by a correspondingly large inclination angle also results, when lowering the load handling means, in the fact that at least too rapid lowering operation of the hoist, in particular at the second speed, is prevented by the evaluation unit, or even lowering operation of the hoist is stopped thereby in order to minimise or prevent the above-mentioned contact of the load handling means and/or carrying means with the ground. This also applies when a state sensor is used and when it detects that the load handling means is free or occupied.

In an advantageous manner, provision can be made that operation of the hoist at the second speed is permitted at the earliest when the inclination angle is at least lower than the predetermined limit value or is zero, but preferably with a delay after the inclination angle has fallen below the predetermined limit value, in particular in an uninterrupted manner, or is zero.

The circumstance is hereby used that for an already raised load the carrying means is tightened and the inclination angle is correspondingly small. Ideally, the load is raised without any swinging and so a value of zero corresponding to the rest position is determined as the inclination angle. Therefore, there is no longer the risk of a critical impulse when raising the load, when the load is actually already raised. However, consideration should be given to situations in which the load handling means is already raised but the load attached to the load handling means by, for example, a flexible lifting accessory is not yet raised. In such situations, there is always a risk of a critical impulse because, even though the determined inclination angle is less than the limit value or has already reached a value of zero owing to the already tightened carrying means, the flexible lifting accessory is possibly not yet sufficiently tightened. The introduction of the load forces emanating from the load into the carrying means and the lifting accessory, which can cause a critical impulse, is thus still imminent in these situations.

The delay is thus predetermined such that after the end of the delay it can be assumed that, owing to operation of the hoist occurring at the first sped until the end of the delay, at least the carrying means and any lifting accessory are sufficiently tightened and have already absorbed corresponding load forces and optionally any load attached to the load handling means is already raised in order to reduce the impulses caused thereby. Since the load handling means is generally not lowered excessively far over the height required for attaching the load, the necessary or sufficient delay can be determined, within which it can be assumed that at least the absorption or introduction of load forces has begun owing to a lifting operation of the hoist. As a result, critical impulses can be prevented that threaten to occur if the hoist was already operated at the second speed during lifting prior to the introduction of load forces into the carrying means.

The delay is optionally predetermined dependent upon time. Provision can be made that after the value falls below the limit value, a predetermined time period must elapse, which, for example, can be set via a timing element connected to the evaluation unit and during which the hoist must be operated at the first speed. The time-dependent delay is in particular in the range between 0.5 s and 10 s, preferably between 0.5 s and 5 s, and in a particularly preferred manner is approximately 2 s to 3 s. Alternatively, a displacement-dependent delay is also feasible, wherein provision can be made that after the value falls below the limit value a predetermined length of the carrying means must be wound by a drum of the hoist. This can be monitored, for example, by means of a speed or displacement sensor. In this context, speeds actually effected in particular by the hoist and the duration thereof can be detected and the wound length can be, in particular continuously, calculated therefrom and from known drum dimensions. For the time-dependent and also displacement-dependent delay, provision can additionally be made that the limit value must not be reached/exceeded at least at the end of the delay, optionally uninterrupted during the delay, in order for the second speed to be permitted. Otherwise, provision can be made that the delay is newly started when the determined inclination angle reaches and/or exceeds the limit value prior to the end of the respective delay or, in the case of a time-dependent delay, the lifting operation of the hoist is slower during the delay than that occurring at the first speed or is temporarily stopped. Prior to the end of the respectively predetermined delay, the second speed is prevented.

In a further aspect of the invention, provision is made that operation of the hoist at the second speed is not only prevented when the inclination angle reaches or exceeds the predetermined limit value, but also when the inclination angle falls below the predetermined limit value or is zero and when in addition, in particular during lifting of the load handling means, a load force applied to the load handling means, which emanates from a load attached to the load handling means and is determined by means of a load sensor, falls below a predetermined limit value. The limit value is preferably up to 500 N, i.e. approximately 50 kg. The desired limit value for the load force can be set, for example, in the evaluation unit and predetermined thereby. Strain gauges, Hall sensors or micro-switches are inter alia feasible as possible load sensors. Optionally, the weight of the lifting accessory does not result in the set limit value of the load sensor being approached, i.e. exceeded. In the cases in which the lifting accessory would already result in the limit value being exceeded, the limit value can be set to be correspondingly higher than as stated above. Alternatively, the implementation of a taring function can be provided. By way of the taring function it is possible that only the net weight of the load and the net load force emanating from the load is detected by the load sensor, but not the weight or load force of the lifting accessory. In accordance with another aspect of the invention, operation of the hoist at the second speed can thus be prevented not only in dependence upon the determined inclination angle and/or the determined state, but in addition also in dependence upon the determined load force.

The limit value is optionally set such that there is still a risk of a critical impulse if the value falls below the limit value. As a result, the situations already described above are likewise considered, in which the carrying means is already tightened and the inclination angle falls below the limit value but a flexible lifting accessory is not yet sufficiently tightened in order to avoid a critical impulse. In these situations, the second speed is thus prevented.

In contrast, operation of the hoist at the second speed is permitted when the inclination angle falls below the limit value and when in addition, in particular during lifting of the load handling means, a load force applied to the load handling means that is determined by means of the load sensor, reaches or exceeds the limit value or even falls below the limit value after the end of a delay. In accordance with yet another aspect of the invention, operation of the hoist at the second speed can thus be permitted not only in dependence upon the determined inclination angle and/or the determined state, but also in dependence upon the determined load force.

The delay can be time-dependent or displacement-dependent in the meaning already described above. An increase in the load force reaching the limit value within the respective delay is then interpreted as a completed sufficient tightening of the carrying means and any lifting accessory, and already begun introduction of load forces into the carrying means, and so there is no longer a risk of a critical impulse and thus the second speed can be permitted for the further operation of the hoist for lifting the load handling means. The second speed can thus be permitted at a load force-dependent delay.

If at least the determined inclination angle falls below the limit value predetermined for this, or is zero, the lack of such an increase in the load force within the time-dependent or displacement-dependent delay is interpreted such that no load is attached to the load handling means or at least no load which could cause a critical impulse. Despite the value falling below the limit value for the load force, this results in a permission of the second speed delayed in a time-dependent or displacement-dependent manner By means of the respective delay, the reaching and/or exceeding of the limit value for the load force can be expected, for example, already from the beginning of the operation of the hoist occurring at the first speed, or from the moment the value falls below the limit value for the inclination angle or even the moment the inclination angle of zero is reached.

The described time-dependent or displacement-dependent delays when permitting the second speed are in particular advantageous when a state sensor is also used which, when a lifting accessory is attached to the load handling means, determines the state as being “occupied” but does not recognise that no load at all, or no load which could cause a critical impulse, is attached to the lifting accessory. The correspondingly settable delays can be used to avoid the second speed being unnecessarily prevented because the reaching and/or exceeding of the limit value for the load force is expected to no avail.

If a state sensor is used, provision can be made in an advantageous manner that operation of the hoist at the second speed is permitted for lifting when the state sensor recognises that the load handling means is free, in particular even when the determined inclination angle reaches or exceeds the predetermined limit value, such as because the load handling means lies on the ground or a load. This likewise corresponds to permitting the second speed in a situation-dependent manner.

In other words, when using a state sensor, lifting operation of the hoist at the second speed is only prevented in dependence upon a determined inclination angle and/or in dependence upon a determined load force when the load handling means is actually occupied. Otherwise, the determined inclination angle and the determined load force remain out of consideration, irrespective of whether the determined inclination angle or the determined load force falls below, or reaches or exceeds, the respectively predetermined limit value. In order to achieve this function, it is fundamentally thus also sufficient if merely a state sensor is provided, and an inclination sensor and load sensor are omitted. It is likewise possible that when the load handling means is free and the inclination sensor and/or load sensor are provided, neither the inclination angle nor the load force are determined. In such an energy-saving design, the inclination angle and/or load force are thus first determined when previously the state sensor determined that the load handling means is occupied. When a state sensor is used, this thus permits that at least during lifting the second speed is always permitted in situations and is available for an operator when the load handling means is free, because there is no risk of a critical impulse in this case.

In an advantageous manner, provision is made that by means of a signal transmitting module arranged on the load handling means, sensor signals which correspond to the determined inclination angle and/or the determined state and/or the determined load force are transmitted to the evaluation unit arranged outside the load handling means. Alternatively, enable signals or blocking signals for the second speed, which are based on the sensor signals and are generated by the evaluation unit arranged on the load handling means, can be transmitted to the control unit arranged outside the load handling means by means of the signal transmitting module. In dependence upon the sensor signals or enable signals or blocking signals, the evaluation unit prevents or permits the operation of the hoist at the second speed by means of the control unit. In order to avoid complex cabling which leads away from the load handling means and is liable to interference owing to the movements of the load handling means, the signal transmitting module optionally operates in a cable-free manner and can be formed, for example, as a radio module for this purpose. Alternatively, other types of signal transmission or signal transmitting modules are feasible, which use WLAN, Bluetooth, ZigBee or infrared signals for the signal transmission.

In an advantageous manner, provision can be made that power for supplying a sensor system—which includes the inclination sensor and/or the state sensor and/or the load sensor—and/or the signal transmitting module is provided by a power supply unit arranged on the load handling means and having an energy store and/or an active power generating unit, without cabling leading away from the load handling means being required for this purpose. The power is optionally generated by movement of the load handling means during lifting and/or lowering of the load handling means, in particular by means of an electrical generator of the active power generating unit, which is may be formed as a dynamo. The electrical generator can be driven by the turning of a deflection roller arranged on the load handling means, in particular a cable deflection roller, in particular when the hoist is formed as a pulley block and the load handling means includes a lower block having at least one corresponding deflection roller. The energy store may be, for example, a battery which can be charged by the active power generating unit. If the evaluation unit is arranged on the load handling means, the evaluation unit can likewise be supplied with power by the power supply unit.

In accordance with still further aspect of the invention, an improvement is advantageously made to a hoist, in particular of a crane, having a load handling means, a flexible carrying means to which the load handling means to be lifted is attached, and a control unit, by means of which the hoist can be operated at least at a first speed or at a second speed for lifting and/or lowering the load handling means, wherein the first speed is lower than the second speed, and wherein the hoist includes an inclination sensor for determining an inclination angle of the load handling means and/or a state sensor, wherein whether the load handling means is free or occupied can be determined as a state of the load handling means by means of the state sensor, for which purpose the state sensor is formed such that it is able to detect an object, or the presence or absence thereof, and that as a result the state “free” and also the state “occupied” can be recognised for the load handling means irrespective of its position or inclination and also irrespective of any load forces, in particular lifting cable forces, by virtue of the fact that an evaluation unit of the hoist cooperates with the control unit such that the hoist is prevented or permitted by the evaluation unit, in dependence upon the determined inclination angle and/or the determined state, to operate at the second speed by means of the control unit. Consequently, the second speed can be automatically prevented or permitted in a situation-dependent manner, and as a result impulses can be automatically reduced during lifting of the load and in particular a longer service life of the carrying means can be achieved. In relation to the advantages associated herewith, reference is made to the above statements in relation to the method in accordance with the invention, because these advantages apply here mutatis mutandis.

In particular, provision can be made that a sensor system, optionally arranged on the load handling means of the hoist, which sensor system includes the inclination sensor and optionally the state sensor and/or optionally a load sensor, the evaluation unit arranged on or outside the load handling means and the control unit arranged outside the load handling means are configured and cooperate to be able to execute a method in accordance with the invention.

In a structurally simple design, provision can be made that a sensor module is arranged on the load handling means and includes the sensor system and optionally the evaluation unit, and the signal transmitting module is arranged for transmitting the sensor signals, or enable signals, or blocking signals, and in particular the power supply unit is arranged to supply the sensor module—in particular its sensor system and possibly the evaluation unit and signal transmitting module—with power. The signal transmitting module can be in particular part of the sensor module. The sensor module is self-sufficient in terms of power in relation to the surrounding area of the load handling means because no cabling leading away from the load handling means is required in order to supply the sensor module with power by means of the power supply unit.

These and other objects, advantages and features of the invention will become apparent upon review of the following specification in conjunction with the drawings.

### BRIEF DESCRIPTION OF THE DRAWINGS

The invention will be explained in more detail hereinunder with the aid of exemplified embodiments illustrated in drawings. In the figures:

FIG. 1 shows a bridge crane formed as a single-girder crane;

FIG. 2 shows a side view of a load handling means of the bridge crane from FIG. 1 in an inclined position with a non-tightened, loose cable and a sensor module in accordance with the invention; and

FIG. 3 shows a side view of the load handling means from FIG. 2 in the vertical position, with a tightened cable and the sensor module.

### DESCRIPTION OF THE PREFERRED EMBODIMENTS

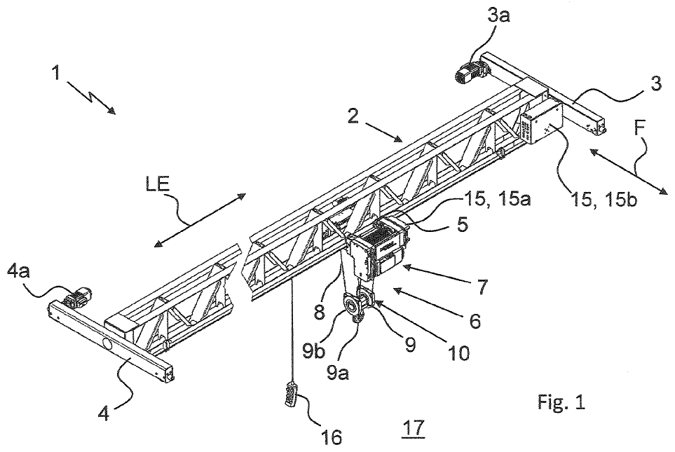

FIG. 1 shows a crane 1 designed as a single-girder bridge crane. The crane 1 includes a crane girder 2 formed as a lattice girder which extends with its longitudinal extent LE horizontally and transversely, in particular perpendicularly, to a crane travel direction F.

Of course, the crane 1 can also be formed as a single-girder gantry crane having a corresponding crane girder 2 supported by vertical gantry supports. Likewise, the crane 1 can be formed as a dual-girder bridge crane or as a dual-girder gantry crane and may include two crane girders 2 accordingly. The explanations given hereinafter using the crane 1 formed as a single-girder bridge crane are transferable accordingly.

With first and second running gear units 3, 4 attached to its mutually opposing ends, the crane girder 2 of the crane 1 forms a crane bridge which is substantially in a double T shape as seen in a plan view. The crane 1 can travel on rails, not illustrated, in the crane travel direction F via the running gear units 3, 4 driven by a motorised crane drive. The rails are typically disposed raised with respect to the ground 17 and for this purpose can be elevated, such as via a suitable support structure, or can be attached to mutually opposing building walls. In order to move the crane 1 or the crane girder 2 thereof, the first running gear unit 3 is driven by a first electric motor 3a of the crane drive and the second running gear unit 4 is driven by a second electric motor 4a of the crane drive.

A crane trolley 5 having a hoist 6 is arranged on the crane girder 2 and can travel, by means of its running gear unit driven by a motorised crane drive, together with the hoist 6 along the longitudinal extent LE of the crane girder 2 and thus transversely to the crane travel direction F. Moreover, a control unit 15 and control switch 16, connected thereto in a control technology and in particular signal-transmitting manner, are arranged on the crane 1 or its crane girder 2, whereby the electric motors 3a, 4a of the crane drive and at least one electric motor of the trolley drive and a motorised lifting drive of a lifting mechanism 7 of the hoist 6 can each be actuated and operated separately from one another. In all of the present embodiments, the control unit 15 can be divided such that one part 15a of the control unit 15 used for actuating the lifting drive and in particular also the trolley drive is arranged on the crane trolley 5 as a lifting or trolley controller and one part 15b of the control unit 15 used to actuate the crane drive is arranged as a crane controller outside the crane trolley 5 on the crane girder 2 or at least one of the running gear units 3, 4. The control switch 16 is formed as a pendant control switch connected by cables, but can also be formed as a wireless remote control unit.

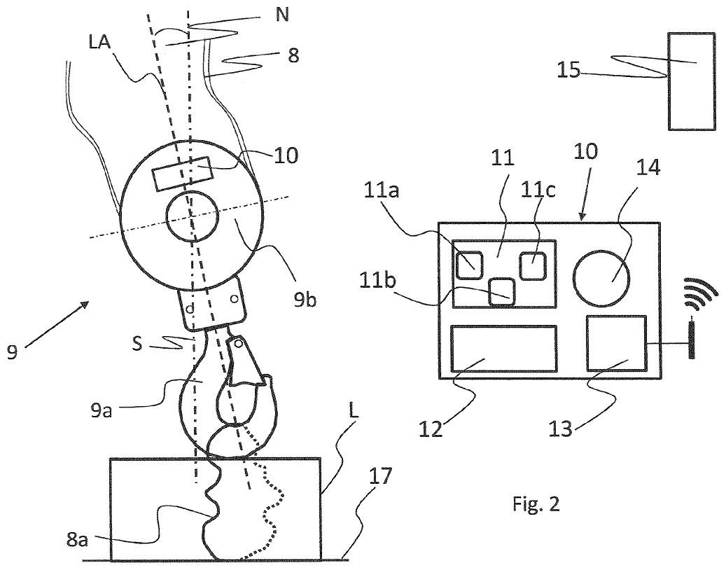

A carrying means 8 formed, for example, as a cable and a load handling means 9 having, optionally, a load L attached to the load handling means 9 (see FIG. 2) can be lifted or lowered via the lifting mechanism 7 of the hoist 6 driven in a motorised manner. The hoist 6, in particular its lifting mechanism 7, can be operated at least at two speeds (v1) and (v2) in order to be able to lift the load handling means 9 alone or with an attached load L, i.e. a load attached to the load handling means 9. The first speed v1 is lower than, or slower than, the second quicker speed v2. For example, the first speed v1 can be in the range of approximately 1-2 m/min and the v1/v2 ratio can be 1/6 or 1/4. More than two speeds are also feasible, wherein the speeds can then be continuously adjustable in particular including the speeds v1 and v2 and the v1/v2 ratio can be considerably higher, e.g. 1/100. The desired speed, in particular the speed v1 or v2, can be triggered by an operator by actuating the control switch 16 accordingly. A corresponding control command is then transmitted in terms of a speed desired value from the control switch 16 to the control unit 15 or the part 15a thereof. The hoist 6, in particular the lifting drive of its lifting mechanism 7, can then be actuated by the control unit 15 and thus can be operated by means of the control unit 15 at the first speed v1 or at the second speed v2 in order to effect corresponding lifting or lowering movement at the desired speed.

The flexible carrying means 8 can, in addition to the exemplified embodiment as a cable, also be designed as a chain or the like and so the hoist 6 is then not formed as a cable winch but as a chain hoist. The load handling means 9 includes by way of example a load hook 9a and is suspended on the carrying means 8 in particular via its lower block 9b with one or more deflection rollers (not illustrated) for the carrying means 8. Accordingly, the cable can be reeved once or multiple times forming a corresponding number of cable strands and thus can be formed as a pulley block. Alternatively, the load handling means 9 can also be attached to the carrying means 8 without deflection rollers or reeving, in particular if the hoist 6 is formed as a chain hoist.

Depending upon the type of load L to be lifted by means of the hoist 6, the load L can be attached to the load handling means 9 directly or by means of a lifting accessory 8a. The lifting accessory 8a for attaching a load L to the load handling means 9 may be, for example, chains, cables or belts which can each form a sling, in particular a round sling. Corresponding slings are generally flexible.

FIG. 2 shows a schematic illustration of the load handling means 9 suspended on the carrying means 8 and in particular its load hook 9a and lower block 9b. A load L is attached to the load handling means 9 by means of a lifting accessory 9a, which is formed as a sling, for example, and is received by the hook jaw of the load hook 9a, the sling being looped around the load. The load handling means 9 is illustrated in an inclined position in which the carrying means 8 and also the lifting accessory 8a are not tightened but are loose. The load handling means 9 includes a sensor module 10 for lifting and/or lowering the load handling means 9, in accordance with the invention, with a load optionally attached thereto, such as the load L. The sensor module 10 is—as illustrated—arranged on the load handling means 9 and can be arranged in particular on the lower block 9b and/or on the load hook 9a. The sensor module 10 schematically illustrated additionally as a detailed view in FIG. 2 in addition to the load handling means 9 includes a sensor system 11 and in the present case also an electronic evaluation unit 12 connected to the sensor system 11 in a signal-transmitting manner. The evaluation unit 12 can alternatively also be arranged outside the load handling means 9, and thus also outside the sensor module 10, and can be arranged on the crane girder 2, for example, and in particular can be integrated in the control unit 15 or at least connected thereto in a signal-transmitting manner.

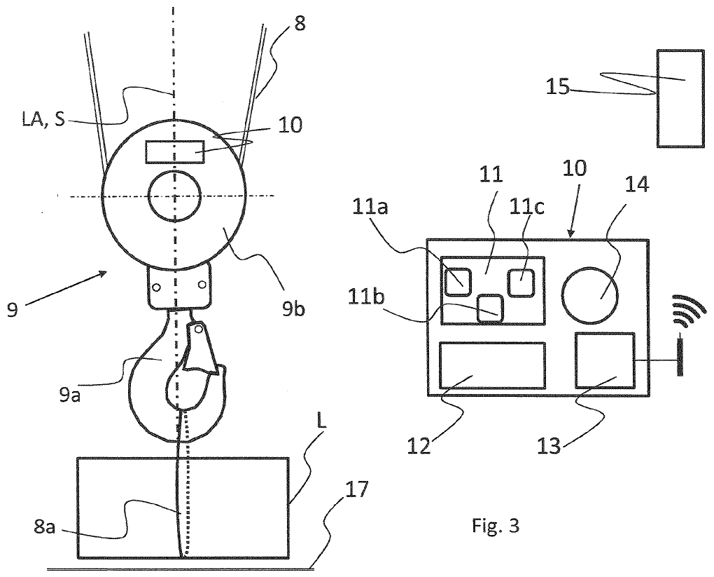

In order to determine, preferably continuously, an inclination angle N of the load handling means 9, the sensor system 11 includes at least one inclination sensor 11a in accordance with a first embodiment. The inclination angle N can relate, for example, to a rest position of the load handling means 9 in which the load handling means 9 is free, i.e. in particular without contact with the ground 17 on the tightened carrying means 8 and suspended therefrom. The rest position thus corresponds to a swinging-free equilibrium position of the freely suspended load handling means 9 in which a longitudinal axis LA of the load handling means 9, which can be used as a reference line, coincides with a perpendicular S corresponding to the direction of gravitational force (see FIG. 3). In the inclined position of the load handling means 9 shown in FIG. 2, the load handling means 9 is inclined with respect to the rest position or the perpendicular S by the inclination angle N owing to the flexible and non-tightened carrying means 8, wherein it lies on the load L lying on the ground 17. Load forces emanating from the load L are not introduced into the carrying means 8 in this position of the load handling means 9 because the carrying means and the lifting accessory 8a are not sufficiently tightened for this purpose. The inclination angle N determined by the inclination sensor 11a is made available to the evaluation unit 12 in particular in the form of corresponding sensor signals and for this purpose are transmitted from the sensor system 11 to the evaluation unit 12.

The evaluation unit 12 evaluates, in accordance with the first embodiment, the sensor signals from the inclination sensor 11a corresponding to the determined inclination angle N and cooperates with the control unit 15 such that the evaluation unit 12, in dependence upon the determined inclination angle N, prevents or permits the hoist 6 from being operated or being able to be operated by means of the control unit 15 at the second, greater, speed v2, in order to lift and/or lower the load handling means 9.

The speed v2 is hereby prevented when the determined inclination angle N of the load handling means 9 deviates from the rest position or the perpendicular S of zero and reaches or exceeds a predetermined limit value, i.e. the load handling means 9 is inclined too much, and is permitted at the earliest when the inclination angle N is less than the predetermined limit value, i.e. the load handling means 9 is inclined to a sufficiently small extent. As the limit value for the inclination angle N, an angle in the range between 0° and 4° is preferably predetermined, and is set, for example, in the evaluation unit 12.

Preventing the hoist 6 from being operated or being able to be operated by the control unit 15 at the speed v2 means in the context of this embodiment and all other embodiments described below that the speed v2 in particular cannot be triggered or executed by the control unit 15 despite an operator actuating the control switch 16 accordingly. In other words, the speed v2 can be blocked in the control unit 15 by the evaluation unit 12 in dependence upon the determined inclination angle N in terms of control technology in the sense of a speed limitation, i.e. a limitation of speed desired values which can be executed by means of the control unit 15.

In this context, provision can be made that the evaluation unit 12 has to actively generate an enable signal for the speed v2 which then has to be transmitted to the control unit 15 and has to be received by the control unit 15 in order to permit the control unit 15 to effect or execute the speed v2 in the case of a corresponding control command. The lack of the enable signal then corresponds to preventing the speed v2 and ensures that the control unit 15 cannot effect or execute the speed v2. Then, for example only the speed v1 can be effected or executed.

Alternatively, it is also feasible that the evaluation unit 12 has to actively generate a blocking signal in relation to the quicker, second speed v2, which signal then has to be transmitted to the control unit 15 and has to be received by the control unit 15 in order to prevent the speed v2 and thus ensure that the control unit 15 cannot effect or execute the second speed v2 in the case of a corresponding control command. The lack of the blocking signal then corresponds to permitting the speed v2 and ensures that the control unit 15 cannot effect or execute the speed v2.

If the speed v2 is prevented in the above sense by the lack of an enable signal or by a blocking signal, control commands of the control switch 16, which in the sense of speed desired values are directed to effecting operation of the hoist 6 at the speed v2 and are triggered by actuating the control switch 16 accordingly, are processed by the control unit 15 only such that the hoist 6 does not execute any lifting or lowering movement at all or is operated only at a speed lower than the speed v2, such as the speed v1. If the speed v2 is permitted by an enable signal or the lack of a blocking signal, the above-mentioned control commands of the control switch 16 can be, in contrast, processed by the control unit 15 such that the hoist 6 is operated at the speed v2.

Permitting the second speed occurs, as already described above, at the earliest when the value falls below the predetermined limit value for the inclination angle N, but preferably with a time-dependent and/or displacement-dependent delay after the value falls below the predetermined limit value.

Owing to the above-described cooperation of the inclination sensor 11a, the evaluation unit 12 and the control unit 15, critical impulses can thus be avoided, which result from situations in which the hoist 6 is operated at the speed v2 although the carrying means 8 and any flexible lifting accessory 8a are not sufficiently tightened as shown in FIG. 2 and accordingly no load forces emanating from the load L into the carrying means 8 are absorbed by the not sufficiently tightened carrying means 8. The above-described risk of contact of the load handling means 9 and/or carrying means 8 with the ground can also be avoided. Such situations can be recognised by corresponding inclination angles N of the load handling means 9 which reach and/or exceed the limit value. Even in the case of a determined inclination angle N of the load handling means 9 which do not reach the limit value, there can still be a risk of a critical impulse during the lifting operation when the lifting accessory 8a is not yet sufficiently tightened. In this case, the speed v2 may then be permitted with a corresponding delay. However, this is not applicable for lowering operation.

A second embodiment differs from the first embodiment in that the sensor system 11 additionally includes a state sensor 11b. The state sensor 11b can be used to continuously determine whether the load handling means 9 is “free” or “occupied” as a state of the load handling means 9. The load handling means 9 has the state “occupied” when a load L or a lifting accessory 8 for attaching a load L to the load handling means 9 is attached directly to the load handling means 9. If the load handling means 9 is formed as a load hook 9a, a corresponding state sensor 11b is also referred to as a hook jaw sensor which can then determine whether the state is “occupied” and accordingly in particular whether or not part of a load L or a lifting accessory 8a is arranged in the hook jaw of the load hook 9a, in particular is lying there. If not, the state is “free”. The respective state of “occupied” or “free” is recognised by the state sensor 11b, which can be, for instance, a sensor operating according to the optical or capacitive principle, in particular a proximity sensor.

The states “occupied” or “free” determined by the state sensor 11b are made available to the evaluation unit 12 in particular in the form of corresponding sensor signals and for this purpose are transmitted from the sensor system 11 to the evaluation unit 12. The evaluation unit 12 evaluates the sensor signals from the inclination sensor 11a corresponding to the determined inclination angle N and the sensor signals from the state sensor 11b corresponding to the state of the load handling means 9 and cooperates with the control unit 15 such that the evaluation unit 12, in dependence upon the determined inclination angle N and/or the determined state, prevents or permits the hoist 6 from being operated or being able to be operated by means of the control unit 15 at the second speed v2, in order to lift and/or lower the load handling means 9.

The speed v2 is permitted by the evaluation unit 12 in the above-described sense when the state sensor 11b recognises that the load handling means 9 is “free”. This also applies, with the exception of the lowering operation of the hoist 6, in particular when the determined inclination angle N reaches or exceeds the predetermined limit value. The speed v2 is thus permitted in the lifting operation solely in dependence upon the state determined by the state sensor 11b and independently of the determined inclination angle N or the corresponding sensor signals from the inclination sensor 11a when the state of the load handling means 9 is “free”. When the state of the load handling means 9 is “occupied”, the speed v2 is permitted, optionally with the above-described delay, or prevented during lifting and/or lowering in dependence upon the state determined by the state sensor 11b and additionally, as per the first embodiment, in dependence upon the inclination angle N.

Owing to this cooperation of the inclination sensor 11a, the state sensor 11b, the evaluation unit 12 and the control unit 15, it can be avoided—in cases where the load handling means 9 is free—that the speed b2 is prevented because the limit value for the inclination angle N is reached and/or exceeded even though there is no risk of critical impulse owing to the fact that the load handling means 9 is free. Therefore, in these cases the speed v2 can be permitted in particular independently of the inclination angle N and thus from the outset, i.e. immediately at the start of a lifting process for lifting the load handling means 9 and without a delay.

A third embodiment, as an alternative to the second embodiment, differs from the first embodiment in that the sensor system 11 includes a load sensor 11c in addition to the inclination sensor 11a. The load sensor 11c is used to determine a load force applied to the load handling means 9, the force emanating from a load L attached to the load handling means 9. By determining the load force multiple times and in particular continuously by means of the load sensor 11c, an increase in the load force can also be determined. The load forces determined by the load sensor 11c are made available to the evaluation unit 12 in particular in the form of corresponding sensor signals and for this purpose are transmitted from the sensor system 11 to the evaluation unit 12. The evaluation unit 12 evaluates the sensor signals from the inclination sensor 11a corresponding to the determined inclination angle N and the sensor signals from the load sensor 11c corresponding to the determined load forces and cooperates with the control unit 15 such that the evaluation unit 12, in dependence upon the determined inclination angle N and the determined load force, prevents or permits the hoist 6 from being operated or being able to be operated by means of the control unit 15 at the second, greater, speed v2, in order to lift the load handling means 9.

In contrast to the first embodiment, a lifting operation of the hoist 6 at the speed b2 can thus also be prevented in the above sense when the determined inclination angle N is less than the predetermined limit value and in particular has already reached a value of zero but when in addition the load force determined by the load sensor 11c is less than a predetermined limit value, which is, for example, up to 500 N. Likewise, in contrast to the first embodiment, it is possible to permit the speed v2 for a lifting operation in the above sense at the earliest when the determined inclination angle N is less than the predetermined limit value and when in addition the load force determined by the load sensor 11c reaches and/or exceeds the predetermined limit value or, as already described above, is still less than the limit value even after the end of a predetermined time-dependent or displacement-dependent delay.

Owing to this cooperation of the inclination sensor 11a, load sensor 11c, evaluation unit 12 and control unit 15, it can be avoided that that the speed v2 is permitted solely owing to the fact that the value is less than the limit value for the inclination angle N. In particular in the cases already mentioned above, in which a flexible lifting accessory 8a is used, a critical impulse as a result of a not yet sufficiently tightened lifting accessory 8a can be avoided in that the speed v2 is only permitted with a corresponding delay.

A particularly preferred fourth embodiment is achieved by combining the second and third embodiments. Accordingly, the sensor system 11 includes the inclination sensor 11a and the state sensor 11b of the second embodiment and the load sensor 11c of the third embodiment. The evaluation unit 12 evaluates the sensor signals from all three sensors 11a, 11b, 11c and cooperates with the control unit 15 such that the evaluation unit 12, in dependence upon the state determined by the state sensor 11b and/or in dependence upon the inclination angle N determined by the inclination sensor 11a and the load force determined by the load sensor 11c, prevents or permits the hoist 6 from being operated or being able to be operated by means of the control unit 15 at the second, greater, speed v2, in order to lift and/or lower the load handling means 9.

The speed v2 is then permitted by the evaluation unit 12 in the above described sense in the lifting operation of the hoist 6 as per the second embodiment solely in dependence upon the state determined by the state sensor 1b when the state sensor 11b recognises that the load handling means 9 is “free”. In contrast, when the state of the load handling means 9 is “occupied”, the speed v2 is permitted, optionally with the above-described delay, or prevented during lifting and/or lowering in dependence upon the state determined by the state sensor 11b and additionally, as per the third embodiment, in dependence upon the determined inclination angle N and the determined load force.

Owing to this cooperation of the inclination sensor 11a, the state sensor 11b, the load sensor 11c, the evaluation unit 12 and the control unit 15, it can be avoided—in cases where the load handling means 9 is free—that the speed v2 is prevented because the limit value for the inclination angle N is reached and/or exceeded or the limit value for the load force is not reached, even though there is no risk of critical impulse owing to the fact that the load handling means 9 is free. Therefore, in these cases the speed v2 can be permitted in particular independently of the inclination angle N and the load force and thus from the outset, i.e. immediately at the start of a lifting process for lifting the load handling means 9 and without a delay. In cases where the load handling means 9 is occupied, it can be avoided—in particular owing to the delayed permission of the speed v2—that the speed v2 is permitted solely owing to the limit value for the inclination angle N not being reached and that then a critical impulse is caused owing to a not yet sufficiently tightened carrying means 8 or lifting accessory 8a. The above statements also apply accordingly when permitting or preventing the speed v2, when lowering, in dependence upon the situation.

FIG. 3 shows a schematic illustration of the load handling means 9 suspended on the carrying means 8 and in particular its load hook 9a and lower block 9b as well as the sensor module 10 with the load L being raised, the load being attached to the load handling means 9 by means of the lifting accessory 8a. The load handling means 9 is in a perpendicular position which corresponds to the above-defined rest position. The inclination angle N is accordingly zero and the longitudinal axis LA of the load handling means 9 used as a reference line coincides with the perpendicular S. The carrying means 8 and also the lifting accessory 8a are tightened and so load forces emanating from the load L are introduced into the carrying means 8 and are absorbed thereby. As soon as the lifting forces introduced by the lifting mechanism 7 of the hoist 6 into the carrying means 8 exceed the load forces, the load L is raised, as has already occurred in FIG. 3.

Because the load handling means 9 can move together with its sensor module 10 relative to the control unit 15 and in particular also relative to the crane girder 2 and/or crane trolley 5, particular provisions should be made when implementing the sensor module 10 on the load handling means 9 in terms of the power supply and signal transmission, i.e. the transmission of sensor signals or enable signals and blocking signals, between the sensor module 10, in particular its sensor system 11, the evaluation unit 12 and the control unit 15. Preferably, the power supply and signal transmission are thus implemented in all embodiments without cabling leading away from the load handling means 9 and in particular without cabling between the load handling means 9 or the sensor module 10 at that location and the control unit 15.

For the signal transmission, accordingly free of cables, to the control unit 15 arranged outside the load handling means 9, a corresponding signal transmitting module 13 such as in the form of a radio module is used. If the evaluation unit 12 is arranged on the load handling means 9, the above-described enable signals or blocking signals are transmitted if need be from the signal transmitting module 13 to the control unit 15. If the evaluation unit 12 is arranged outside the load handling means 9, the sensor signals determined by the sensor system 11 are transmitted to the evaluation unit 12 via the signal transmitting module 13 and are made available thereto. Any generation of corresponding enable signals or blocking signals by the evaluation unit 12 and the transmission thereof to the control unit 15 then takes place if need be outside the load handling means 9.

The power supply, free of cables, of the sensor module 10, in particular the sensor system 11, evaluation unit 12 and the signal transmitting module 13 is effected locally via a power supply unit 14 arranged on the load handling means 9 and having an energy store, which may include, for example, one or more batteries, rechargeable batteries, capacitors, and/or having an active power generating unit. In a preferred embodiment, as an alternative to or in addition to an energy store, an electrical generator, such as in the form of a dynamo, as an active power generating unit is used as an essential component of the power supply unit 14. It is readily possible to use the rotation of any deflection roller for generating power. As soon as the deflection roller rotates by lifting or lowering the load handling means 9, the generator is driven thereby and the sensor module 10 is supplied with power or any energy store is charged. The functions, in accordance with the invention, of the sensor module 10 arranged on the load handling means 9, in particular the sensor system 11 and the evaluation unit 12 arranged if need be on the load handling means 9, the signal transmitting module 13 or its respective cooperation with the control unit 15 can thus be implemented.

Changes and modifications in the specifically-described embodiments may be carried out without departing from the principles of the present invention, which is intended to be limited only by the scope of the appended claims as interpreted according to the principles of patent law including the doctrine of equivalents.

1. A method for lifting or lowering a load handling means of a crane hoist, said method comprising:
providing a flexible carrying means to which the load handling means is attached;
operating the hoist at least at a first speed or a second speed with a control unit, for lifting or lowering the load handling means, wherein the first speed is lower than the second speed;
determining either:
(i) an inclination angle of the load handling means by an inclination sensor; or
(ii) a free or occupied state of the load handling means by a state sensor, wherein the state sensor is configured to detect the presence or absence of an object, wherein the free state and also the occupied state can be recognised for the load handling means irrespective of its position or inclination, and irrespective of any lifting cable load forces;
operating an evaluation unit in cooperation with the control unit to prevent or permit the hoist to operate at the second speed according to the determined inclination angle or the determined free or occupied state of the load handling means.

2. The method as claimed in claim 1, wherein the inclination angle is determined relative to a rest position of the load handling means suspended on a carrying means of the hoist.

3. The method as claimed in claim 1, wherein the hoist is prevented from operating at the second speed is for lifting or lowering of the load handling means when the inclination angle reaches or exceeds a limit value between 0° and 10° and the state sensor detects that the load handling means is occupied.

4. The method as claimed in claim 3, wherein the hoist is permitted to operate at the second speed after a delay following the inclination angle falling below the limit value in an uninterrupted manner.

5. The method as claimed in claim 3 wherein the hoist is prevented from operating at the second speed is for lifting when the inclination angle is less than the limit value and when a load force applied to the load handling means is less than a limit value of up to 500 N, and wherein the load force is determined by a load sensor.

6. The method as claimed in claim 3, wherein the hoist is permitted to operate at the second speed for lifting when the inclination angle is lower than the limit value and when a load force applied to the load handling means reaches or exceeds the limit value or falls below the limit value after a delay, and wherein the load force is determined by a load sensor.

7. The method as claimed in claim 1, wherein the hoist is permitted to operate at the second speed for lifting when the state sensor detects that the load handling means regardless of whether or not the inclination angle reaches or exceeds a limit value between 0° and 10°.

8. The method of claim 5, further comprising at least one chosen from:
(i) transmitting sensor signals from a signal transmitting module arranged on the load handling means to the evaluation unit arranged outside the load handling means, wherein the sensor signals correspond to the determined inclination angle or the determined state or the determined load force to prevent or permit, in dependence upon the sensor signals, operating the hoist at the second speed by means of the control unit; and
(ii) transmitting enable signals or blocking signals for the second speed and generated by the evaluation unit arranged on the load handing means, from a signal transmitting module arranged on the load handling means to the control unit arranged outside the load handling means to prevent or permit, in dependence upon the enable signals or blocking signals operating the hoist at the second speed by means of the control unit.

9. The method as claimed in claim 8, wherein power for a sensor system including at least one chosen from the inclination sensor, the state sensor, the load sensor, and the signal transmitting module, is provided by a power supply unit arranged on the load handling means and having an energy store or an active power generating unit, wherein the power is generated by movement of the load handling means during lifting or lowering of the load handling means, and wherein the power is generated by an electrical generator of the active power generating unit.

10. A crane hoist comprising:
a load handling means;
a flexible carrying means to which the load handling means is attached for lifting;
a control unit configured to operate the hoist at least at a first speed or at a second speed for lifting or lowering the load handling means, wherein the first speed is lower than the second speed;
an inclination sensor for determining an inclination angle of the load handling means or a state sensor operable to determine a free state or an occupied state of the load handling means wherein the state sensor operable to detect the presence or the absence of an object to determine the free state or occupied state of the load handling means; and
an evaluation unit in communication with the control unit such that operation of the hoist at the second speed is prevented or permitted by the evaluation unit based on the inclination angle or the state of the load handling means.

11. (canceled)

12. The hoist as claimed in claim 10, further comprising:
a sensor module that includes a sensor system and the evaluation unit;
a signal transmitting module for transmitting sensor signals, or enable signals or blocking signals; and
a power supply unit;
wherein the sensor module and the signal transmitting module are arranged on the load handling means, and wherein the power supply unit is configured to supply at least the sensor system of the sensor module with power.

13. The method as claimed in claim 2, wherein the hoist is prevented from operating at the second speed for lifting or lowering of the load handling means when (i) the inclination angle reaches or exceeds a limit value between 0° and 10° and (ii) the state sensor indicates that the load handling means is occupied.

14. The method as claimed in claim 2, wherein the hoist is permitted to operate at the second speed for lifting when (i) the state sensor detects that the load handling means is free and (ii) the inclination angle reaches or exceeds a limit value between 0° and 10°.

15. The method as claimed in claim 3, wherein the hoist is permitted to operate at the second speed for lifting when the state sensor detects that the load handling means is free, regardless of whether or not the inclination angle reaches or exceeds a limit value between 0° and 10°.

16. The method as claimed in claim 4, wherein the hoist is prevented from operating at the second speed for lifting when (i) the inclination angle is lower than the limit value and (ii) a load force applied to the load handling means is less than a limit value of up to 500 N, and wherein the load force is determined by a load sensor.

17. The method as claimed in claim 4, wherein the hoist is permitted to operate at the second speed for lifting when the inclination angle is lower than the limit value and when a load force applied to the load handling means (i) reaches or exceeds the limit value or (ii) falls below the limit value after the delay, and wherein the load force is determined by a load sensor.

18. The method as claimed in claim 5, wherein the hoist is permitted to operate at the second speed for lifting when the inclination angle is lower than the limit value and when a load force applied to the load handling means (i) reaches or exceeds the limit value or (ii) falls below the limit value after a delay, and wherein the load force is determined by a load sensor.

19. The method as claimed in claim 9, wherein the electrical generator of the active power generating unit is a dynamo.
